(19) United States
(12) Patent Application Publication
(10) Pub. No.: US 2016/0112491 A1
(43) Pub. Date: Apr. 21, 2016

(54) METHOD AND DEVICE FOR IDENTIFYING ENCODING OF WEB PAGE

(71) Applicant: Xiaomi Inc., Beijing (CN)

(72) Inventors: Jinglong ZUO, Beijing (CN); Jinsong FAN, Beijing (CN); Fan TIAN, Beijing (CN)

(73) Assignee: Xiaomi Inc.

(21) Appl. No.: 14/684,855

(22) Filed: Apr. 13, 2015

Related U.S. Application Data
(63) Continuation of application No. PCT/CN2015/071308, filed on Jan. 22, 2015.

(30) Foreign Application Priority Data
Oct. 21, 2014 (CN) 201410562477.9

(51) Int. Cl. H04L 29/08; H04L 29/06

(52) U.S. Cl. CPC H04L 67/02; H04L 69/08

(57) ABSTRACT

A method for a device to identify encoding of a web page, includes: loading web page data including a web page resource; detecting whether the web page resource is a HyperText Markup Language (HTML) resource and whether the web page resource specifies an encoding mode; if the web page resource is an HTML resource and the web page resource does not specify an encoding mode, identifying the encoding mode of the HTML resource; and decoding the HTML resource with a decoding mode corresponding to the identified encoding mode.

### CROSS-REFERENCE TO RELATED APPLICATIONS

This application is a continuation of International Application No. PCT/CN2015/071308, filed Jan. 22, 2015, which is based upon and claims priority to Chinese Patent Application No. CN201410562477.9, filed Oct. 21, 2014, the entire contents of all of which are incorporated herein by reference.

### TECHNICAL FIELD

The present disclosure generally relates to the field of computer networks and, more particularly, to a method and a device for identifying encoding of a web page.

### BACKGROUND

With the development of network technologies, one of the most commonly used functions of a terminal is to browse a web page through a browser on the terminal.

Conventionally, web page data may be encoded with various encoding modes, and the terminal needs to identify an encoding mode of the web page data according to a “charset” field in the web page data. The terminal then decodes the web page data with a decoding mode corresponding to the identified encoding mode for displaying the web page.

### SUMMARY

According to a first aspect of the present disclosure, there is provided a method for a device to identify encoding of a web page, comprising: loading web page data including a web page resource; detecting whether the web page resource is a HyperText Markup Language (HTML) resource and whether the web page resource specifies an encoding mode; if the web page resource is an HTML resource and the web page resource does not specify an encoding mode, identifying the encoding mode of the HTML resource; and decoding the HTML resource with a decoding mode corresponding to the identified encoding mode.

According to a second aspect of the present disclosure, there is provided a device, comprising: a processor; and a memory for storing instructions executable by the processor, wherein the processor is configured to: load web page data including a web page resource; detect whether the web page resource is a HyperText Markup Language (HTML) resource and whether the web page resource specifies an encoding mode; if the web page resource is an HTML resource and the web page resource does not specify an encoding mode, identify the encoding mode of the HTML resource, and decode the HTML resource with a decoding mode corresponding to the identified encoding mode.

According to a third aspect of the present disclosure, there is provided a non-transitory storage medium having stored therein instructions that, when executed by one or more processors of a device, cause the device to perform a method for identifying encoding of a web page, the method comprising: loading web page data including a web page resource; detecting whether the web page resource is a HyperText Markup Language (HTML) resource and whether the web page resource specifies an encoding mode; if the web page resource is an HTML resource and the web page resource does not specify an encoding mode, identifying the encoding mode of the HTML resource; and decoding the HTML resource with a decoding mode corresponding to the identified encoding mode.

It is to be understood that both the foregoing general description and the following detailed description are exemplary and explanatory only and do not limit the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for identifying encoding of a web page, according to an exemplary embodiment.

FIG. 2 is a flow chart of a method for identifying encoding of a web page, according to an exemplary embodiment.

FIG. 3 is a block diagram of a device for identifying encoding of a web page, according to an exemplary embodiment.

FIG. 4 is a block diagram of a device for identifying encoding of a web page, according to an exemplary embodiment.

FIG. 5 is a block diagram of a device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

In exemplary embodiments, there is provided a method for a terminal to identify encoding of a web page, such that the terminal can decode the web page for display. For example, the terminal may be a mobile phone, a tablet computer, an e-book reader, a Moving Picture Experts Group Audio Layer III (MP3) player, a Moving Picture Experts Group Audio Layer IV (MP4) player, a portable laptop, or a desktop computer, etc.

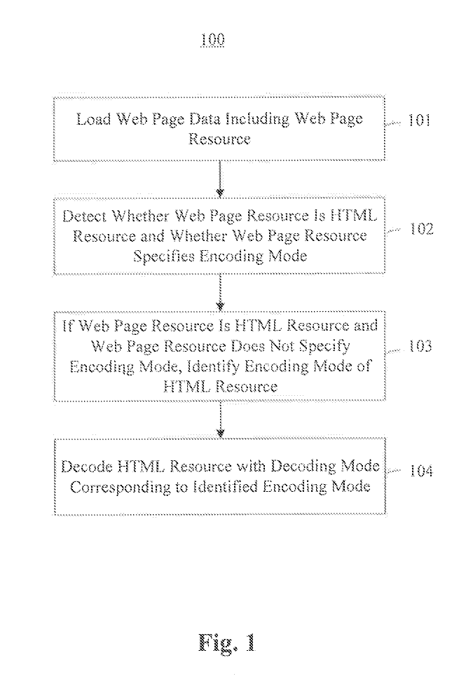

FIG. 1 is the flow chart of a method 100 for identifying encoding of a web page, according to an exemplary embodiment. For example, the method 100 may be used in a terminal. Referring to FIG. 1, the method 100 includes the following steps.

In step 101, the terminal loads web page data including a web page resource. In exemplary embodiments, a web page resource can be one of a HyperText Markup Language (HTML) resource or a Cascading Style Sheets (CSS) resource. For example, HTML is a standard markup language used to create web pages, and may be written in the form of HTML elements, such as tags enclosed in angle brackets. Also for example, CSS is a style sheet language used for describing a look and formatting of a document written in a markup language.

In step 102, the terminal detects whether the web page resource is an HTML resource and whether the web page resource specifies an encoding mode.

In step 103, if the web page resource is an HTML resource and the web page resource does not specify an encoding mode, the terminal identifies the encoding mode of the HTML resource.

In step 104, the terminal decodes the HTML resource with a decoding mode corresponding to the identified encoding mode.

By using the method 100, the terminal can improve accuracy of decoding the web page resource and appropriately display the web page resource.

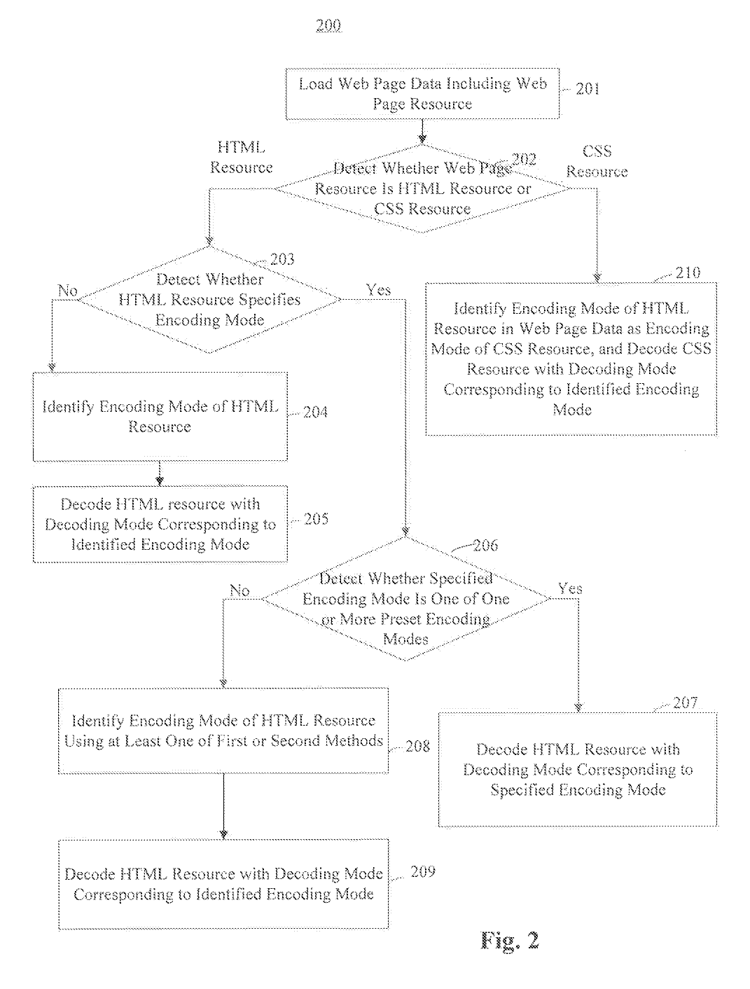

FIG. 2 is a flow chart of a method 200 for identifying encoding of a web page, according to an exemplary embodiment. For example, the method 200 may be used in a terminal. Referring to FIG. 2, the method 200 includes the following steps.

In step 201, the terminal loads web page data including a web page resource.

For example, when the terminal needs to display a web page, data of the web page is firstly loaded, and the data of the web page includes a web page resource. The web page resource can be one of an HTML resource or a CSS resource, as described above in connection with FIG. 1.

In step 202, the terminal detects whether the web page resource is an HTML resource or a CSS resource. If the web page resource is an HTML resource, step 203 is performed. If the web page resource is a CSS resource, step 210 is performed.

In step 203, if the web page resource is an HTML resource, the terminal further detects whether the HTML resource specifies an encoding mode, such as UTF-8 (Universal Character Set Transformation Format—8-bit), Big5 (a Chinese character encoding standard), GB2312 (National Standard for Chinese Character Set), GBK (Extension of National Standard for Chinese Character Set), ISO-8859-1 (a character encoding standard), and ISO-8859-2 (a character encoding standard), etc. For example, the HTML resource may specify the encoding mode in a “charset” field.

If the HTML resource does not specify an encoding mode, step 204 is performed. If the HTML resource specifies an encoding mode, step 206 is performed.

In step 204, if the HTML resource does not specify an encoding mode, the terminal identifies the encoding mode of the HTML resource.

In one exemplary embodiment, the terminal identifies the encoding mode of the HTML resource by calling a preset character encoding identification algorithm. The preset character encoding identification algorithm may be a chardet character encoding identification algorithm.

For example, if the HTML resource does not specify the encoding mode, the terminal calls the chardet character encoding identification algorithm and identifies the encoding mode of the HTML resource to be GB2312.

The chardet character encoding identification algorithm is an algorithm for identifying an encoding format of a character string, which may be used for identifying an encoding format of textual characters.

In exemplary embodiments, to improve the identification speed, the terminal may extract a predetermined length of character string from the HTML resource, and identify the encoding mode of the predetermined length of character string through a preset character encoding identification algorithm, instead of identifying all of the character strings throughout the HTML resource.

In step 205, the terminal decodes the HTML resource with a decoding mode corresponding to the identified encoding mode.

In step 206, if the web page resource specifies an encoding mode, the terminal further detects whether the specified encoding mode is one of one or more preset encoding modes. The preset encoding modes include, but are not limited to: UTF-8, Big5, GB2312, GBK, ISO-8859-1, ISO-8859-2, etc.

If the specified encoding mode is one of the preset encoding modes, step 207 is performed. If the specified encoding mode is not one of the preset encoding modes, step 208 is performed.

In step 207, if the specified encoding mode is one of the preset encoding modes, which indicates there is no spelling error in the specification of the encoding mode, the terminal decodes the HTML resource with a decoding mode corresponding to the specified encoding mode.

In step 208, if the specified encoding mode is not one of the preset encoding modes, which indicates that a spelling error exists in the specification of the encoding mode, the terminal identifies the encoding mode of the HTML resource using at least one of a first method or a second method.

In the first method, the terminal identifies the encoding mode of the HTML resource, similar to step 204. For example, the terminal identifies the encoding mode of the HTML resource by calling a preset character encoding identification algorithm. The preset character encoding identification algorithm may be the chardet character encoding identification algorithm.

In the second method, the terminal performs an automatic correction on the specified encoding mode to obtain an encoding mode after the automatic correction. For example, the terminal calculates a spelling similarity value between the specified encoding mode and each of the preset encoding modes. Also for example, if there are six preset encoding modes, the terminal calculates six spelling similarity values corresponding to the six preset encoding modes, respectively. If a maximum spelling similarity value is larger than a preset threshold, the terminal determines a preset encoding mode corresponding to the maximum spelling similarity value as the encoding mode after the automatic correction.

In one exemplary embodiment, the specified encoding mode of the HTML resource is “GB2812”, and six spelling similarity values are calculated with respect to six preset encoding modes, respectively. The terminal determines that a maximum spelling similarity value 83% is that calculated with respect to the preset encoding mode “GB2312”, which is larger than a preset threshold 60%. Thus, the terminal determines the preset encoding mode “GB2312” as the encoding mode after the automatic correction.

The terminal may use the first method and the second method separately or in combination. For example, the terminal first performs the second method and, if the maximum spelling similarity value is less than a preset threshold, or if the maximum spelling similarity value corresponds to two or more preset encoding modes, the terminal performs the first method to identify the encoding mode of the HTML resource.

In step 209, the terminal decodes the HTML resource with a decoding mode corresponding to the identified encoding mode.

In step 210, if the web page resource is a CSS resource, the terminal identifies the encoding mode of an HTML resource in the web page data as an encoding mode of the CSS resource, and decodes the CSS resource with a decoding mode corresponding to the identified encoding mode.

In the illustrated embodiment, an HTML resource and a CSS resource in the same web page data use the same encoding mode. Accordingly, the terminal identifies the encoding mode of the HTML resource in the web page data as the encoding mode of the CSS resource. For example, the terminal identifies the encoding mode of the HTML resource according to steps 203 to 207.

After all web page resources in the web page data are decoded, the terminal displays the web page according to the decoded web page resources.

The following are embodiments of devices of the present disclosure, which may be configured to perform the above described methods.

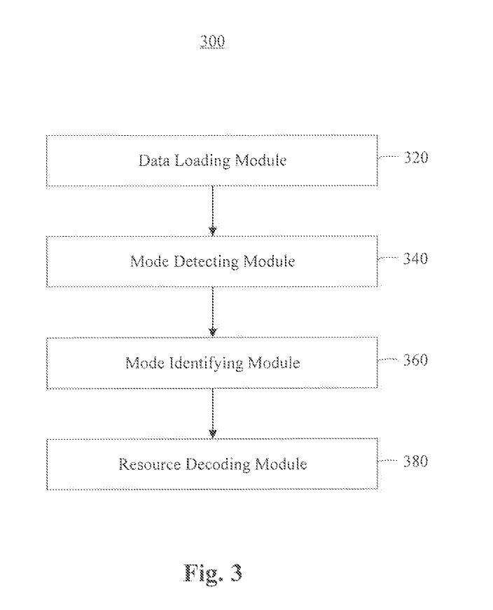

FIG. 3 is a block diagram of a device 300 for identifying encoding of a web page, according to an exemplary embodiment. The device 300 may be implemented by software, hardware, or a combination of both, as a part of a terminal or the whole terminal.

Referring to FIG. 3, the device 300 includes a data loading module 320 configured to load web page data including at least one web page resource, and a mode detecting module 340 configured to detect whether the web page resource is an HTML resource and whether the web page resource specifies an encoding mode. The device 300 also includes a mode identifying module 360 configured to, if the web page resource is an HTML resource and the web page resource does not specify the encoding mode, identify the encoding mode of the HTML resource, and a resource decoding module 380 configured to decode the HTML resource with a decoding mode corresponding to the identified encoding mode.

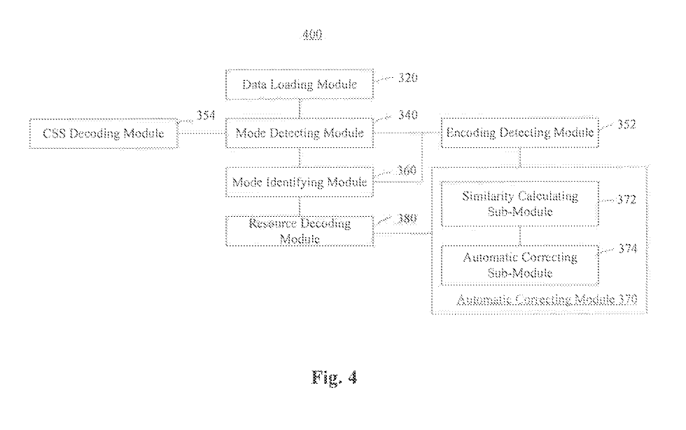

FIG. 4 is a block diagram of a device 400 for identifying encoding of a web page, according to an exemplary embodiment. The device 400 may be implemented by software, hardware, or a combination of both, as a part of a terminal or the whole terminal.

Referring to FIG. 4, the device 400 includes the data loading module 320, the mode detecting module 340, the mode identifying module 360, and the resource decoding module 380 (FIG. 3).

In exemplary embodiments, the device 400 further includes an encoding detecting module 352 configured to, if the web page resource is an HTML resource and the web page resource specifies an encoding mode, detect whether the specified encoding mode is one of one or more preset encoding modes.

The mode identifying module 360 is configured to, if the specified encoding mode is not one of the preset encoding modes, identify the encoding mode of the HTML resource. For example, the mode identifying module 360 identifies the encoding mode of the HTML resource by calling a preset character encoding identification algorithm.

In exemplary embodiments, the device 400 also includes an automatic correcting module 370 configured to, if the specified encoding mode is not one of the preset encoding modes, perform an automatic correction on the specified encoding mode, to obtain an encoding mode after the automatic correction.

In exemplary embodiments, the automatic correcting module 370 includes a similarity calculating sub-module 372 configured to calculate a spelling similarity value between the specified encoding mode and each of the preset encoding modes, and an automatic correcting sub-module 374 configured to, if a maximum spelling similarity value is larger than a preset threshold, determine a preset encoding mode corresponding to the maximum spelling similarity value as the encoding mode after the automatic correction.

In exemplary embodiments, the device 400 further includes a CSS decoding module 354 configured to, if the web page resource is a CSS resource, identify the encoding mode of the HTML resource in the web page data as an encoding mode of the CSS resource, and decode the CSS resource with a decoding mode corresponding to the identified encoding mode.

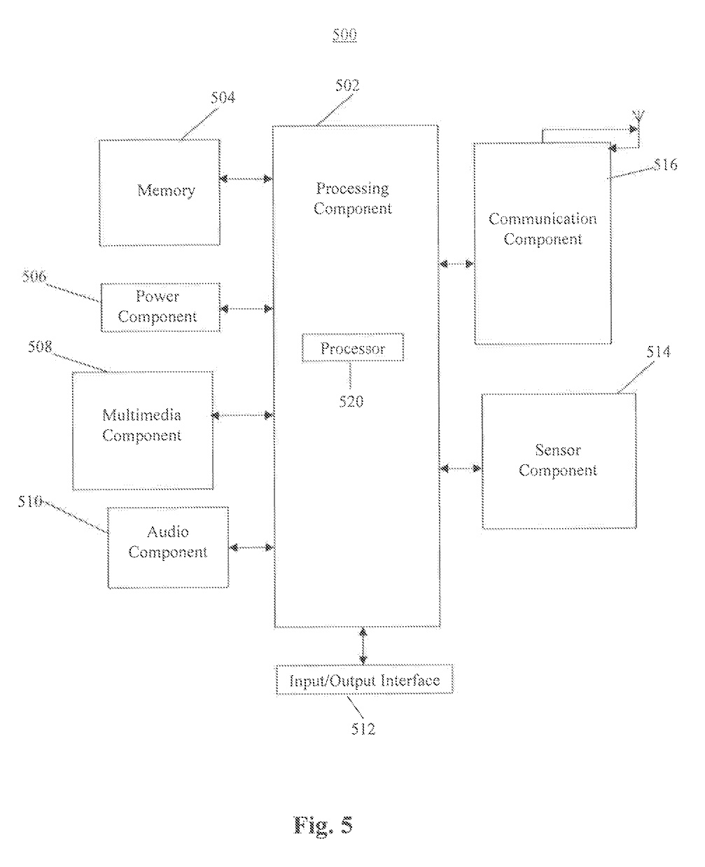

FIG. 5 is a block diagram of a device 500, according to an exemplary embodiment. For example, the device 500 may be a mobile phone, a computer, a digital broadcast terminal, a messaging device, a gaming console, a tablet, a medical device, exercise equipment, a personal digital assistant, and the like.

Referring to FIG. 5, the device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504, executable by the processor 520 in the device 500, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being specified by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for a device to identify encoding of a web page, comprising:
loading web page data including a web page resource;
detecting whether the web page resource is a HyperText Markup Language (HTML) resource and whether the web page resource specifies an encoding mode;
if the web page resource is an HTML resource and the web page resource does not specify an encoding mode, identifying the encoding mode of the HTML resource; and
decoding the HTML resource with a decoding mode corresponding to the identified encoding mode.

2. The method of claim 1, further comprising:
if the web page resource is an HTML resource and the web page resource specifies an encoding mode, detecting whether the specified encoding mode is one of one or more preset encoding modes; and
if the specified encoding mode is not one of the one or more preset encoding modes, performing at least one of:
identifying the encoding mode of the HTML resource; or
performing an automatic correction on the specified encoding mode to obtain the encoding mode after the automatic correction.

3. The method of claim 1, wherein the identifying of the encoding mode of the HTML resource comprises:
identifying the encoding mode of the HTML resource by calling a preset character encoding identification algorithm.

4. The method of claim 2, wherein if the specified encoding mode is not one of the one or more preset encoding modes, the identifying of the encoding mode of the HTML resource comprises:
identifying the encoding mode of the HTML resource by calling a preset character encoding identification algorithm.

5. The method of claim 2, wherein the performing of the automatic correction on the specified encoding mode to obtain the encoding mode after the automatic correction comprises:
calculating a spelling similarity value between the specified encoding mode and each of the one or more preset encoding modes; and
if a maximum spelling similarity value is larger than a preset threshold, determining a preset encoding mode corresponding to the maximum spelling similarity value as the encoding mode after the automatic correction.

6. The method of claim 1, further comprising:
if the web page resource is a Cascading Style Sheets (CSS) resource, identifying the encoding mode of the HTML resource in the web page data as an encoding mode of the CSS resource, and decoding the CSS resource with the decoding mode corresponding to the identified encoding mode.

7. A device, comprising:
a processor; and
a memory for storing instructions executable by the processor,
wherein the processor is configured to:
load web page data including a web page resource;
detect whether the web page resource is a HyperText Markup Language (HTML) resource and whether the web page resource specifies an encoding mode;
if the web page resource is an HTML resource and the web page resource does not specify an encoding mode, identify the encoding mode of the HTML resource, and
decode the HTML resource with a decoding mode corresponding to the identified encoding mode.

8. The device of claim 7, wherein the processor is further configured to:
if the web page resource is an HTML resource and the web page resource specifies an encoding mode, detect whether the specified encoding mode is one of one or more preset encoding modes; and
if the specified encoding mode is not one of the one or more preset encoding modes, perform at least one of:
identifying the encoding mode of the HTML resource; or,
performing an automatic correction on the specified encoding mode to obtain the encoding mode after the automatic correction.

9. The device of claim 7, wherein the processor is further configured to:
identify the encoding mode of the HTML resource by calling a preset character encoding identification algorithm.

10. The device of claim 8, wherein if the specified encoding mode is not one of the one or more preset encoding modes, the processor is further configured to:
identify the encoding mode of the HTML resource by calling a preset character encoding identification algorithm.

11. The device of claim 8, wherein if the specified encoding mode is not one of the one or more preset encoding modes, the processor is further configured to:
calculate a spelling similarity value between the specified encoding mode and each of the one or more preset encoding modes; and
if a maximum spelling similarity value is larger than a preset threshold, determine a preset encoding mode corresponding to the maximum spelling similarity value as the encoding mode after the automatic correction.

12. The device of claim 7, wherein the processor is further configured to:
if the web page resource is a Cascading Style Sheets (CSS) resource, identify the encoding mode of the HTML resource in the web page data as an encoding mode of the CSS resource, and decode the CSS resource with the decoding mode corresponding to the identified encoding mode.

13. A non-transitory storage medium having stored therein instructions that, when executed by one or more processors of a device, cause the device to perform a method for identifying encoding of a web page, the method comprising:
loading web page data including a web page resource;
detecting whether the web page resource is a HyperText Markup Language (HTML) resource and whether the web page resource specifies an encoding mode;
if the web page resource is an HTML resource and the web page resource does not specify an encoding mode, identifying the encoding mode of the HTML resource; and
decoding the HTML resource with a decoding mode corresponding to the identified encoding mode.

14. The non-transitory storage medium of claim 13, wherein the method further comprises:
if the web page resource is an HTML resource and the web page resource specifies an encoding mode, detecting whether the specified encoding mode is one of one or more preset encoding modes; and
if the specified encoding mode is not one of the one or more preset encoding modes, performing at least one of:
identifying the encoding mode of the HTML resource; or
performing an automatic correction on the specified encoding mode to obtain the encoding mode after the automatic correction.

15. The non-transitory storage medium of claim 13, wherein the identifying of the encoding mode of the HTML resource comprises:
identifying the encoding mode of the HTML resource by calling a preset character encoding identification algorithm.

16. The non-transitory storage medium of claim 14, wherein if the specified encoding mode is not one of the one or more preset encoding modes, the identifying of the encoding mode of the HTML resource comprises:
identifying the encoding mode of the HTML resource by calling a preset character encoding identification algorithm.

17. The non-transitory storage medium of claim 14, wherein the performing of the automatic correction on the specified encoding mode to obtain the encoding mode after the automatic correction comprises:
calculating a spelling similarity value between the specified encoding mode and each of the one or more preset encoding modes; and
if a maximum spelling similarity value is larger than a preset threshold, determining a preset encoding mode corresponding to the maximum spelling similarity value as the encoding mode after the automatic correction.

18. The non-transitory storage medium of claim 13, wherein the method further comprises:
if the web page resource is a Cascading Style Sheets (CSS) resource, identifying the encoding mode of the HTML resource in the web page data as an encoding mode of the CSS resource, and decoding the CSS resource with the decoding mode corresponding to the identified encoding mode.
